(19) United States
(12) Patent Application Publication
(10) Pub. No.: US 2022/0013816 A1
(43) Pub. Date: Jan. 13, 2022

(54) SOLID-STATE BATTERY

(71) Applicant: Murata Manufacturing Co., Ltd., Nagaokakyo-shi (JP)

(72) Inventors: Mitsuyoshi Nishide, Nagaokakyo-shi (JP); Osamu Chikagawa, Nagaokakyo-shi (JP)

(21) Appl. No.: 17/487,511

(22) Filed: Sep. 28, 2021

Related U.S. Application Data
(63) Continuation of application No. PCT/JP2020/014301, filed on Mar. 27, 2020.

(30) Foreign Application Priority Data
Mar. 29, 2019 (JP) 2019-068097

(51) Int. Cl. H01M 10/42; H01M 10/658; H01M 10/46; H01M 10/63; H01M 10/0562

(52) U.S. Cl. CPC H01M 10/4257; H01M 10/658; H01M 10/46; H01M 2220/30; H01M 10/0562; H01M 2300/0068; H01M 2010/4271; H01M 10/63

(57) ABSTRACT

A solid-state battery that includes a solid-state battery laminate having a main surface configured as a circuit forming surface; and a circuit that controls the solid-state battery on the main surface.

### CROSS REFERENCE TO RELATED APPLICATIONS

The present application is a continuation of International application No. PCT/JP2020/014301, filed Mar. 27, 2020, which claims priority to Japanese Patent Application No. 2019-068097, filed Mar. 29, 2019, the entire contents of each of which are incorporated herein by reference.

### FIELD OF THE INVENTION

The present invention relates to a solid-state battery. More specifically, the present invention relates to a solid-state battery made compact so as to be suitable for substrate mounting.

### BACKGROUND OF THE INVENTION

In the related art, secondary batteries that can be repeatedly charged and discharged have been used for various purposes. For example, the secondary battery has been used as a power source of an electronic device such as a smartphone and a notebook computer.

In the secondary battery, a liquid electrolyte has been generally used as a medium for ion transfer that contributes to charging and discharging. That is, a so-called electrolytic solution is used for the secondary battery. However, in such a secondary battery, safety is generally required in terms of preventing leakage of the electrolytic solution. In addition, an organic solvent or the like used for the electrolytic solution is a flammable substance, and thus the safety is also required.

Therefore, a solid-state battery using a solid electrolyte instead of the electrolytic solution has been studied.

Patent Document 1: Japanese Patent Application Laid-Open No. 2001-052751

### SUMMARY OF THE INVENTION

The inventors of the present application have noticed that there is still a problem to be overcome in the previously proposed solid-state battery, and have found a need to take measures therefor. Specifically, the inventors of the present application have found that there are the following problems.

It is known that the solid-state battery is used by being mounted on a substrate surface such as a printed wiring board together with other electronic components, and in that case, a battery suitable for mounting is required. When the solid-state battery is mounted on the substrate surface, a protective circuit for electrically and thermally protecting the solid-state battery, a charge and discharge control circuit, and the like may be required, and the size of a mounting space may be increased.

The solid-state battery disclosed in Patent Document 1 has a configuration in which a resin substrate including a circuit is stacked on a battery element, and is proposed as contributing to compactness. However, in such a case, it is necessary to use a circuit board as a member different from the battery element, and it is difficult to say that the solid-state battery is a sufficiently compact.

The present invention has been made in view of such problems. That is, a main object of the present invention is to provide a solid-state battery that contributes to further compactness.

The inventors of the present application have tried to solve the above problems by addressing in a new direction instead of addressing in an extension of the related art. As a result, the present inventors have reached the invention of a solid-state battery in which the above main object has been achieved.

The present invention provides a solid-state battery that includes a solid-state battery laminate having a main surface configured as a circuit forming surface; and a circuit that controls the solid-state battery on the main surface.

The solid-state battery according to the present invention is a more compact solid-state battery suitable for surface mounting.

More specifically, from the viewpoint of compactness, a “circuit that controls the solid-state battery” is provided on the main surface of the solid-state battery. Therefore, the present invention provides a compact solid-state battery in that it is not necessary to separately provide a circuit for the solid-state battery on a substrate.

### BRIEF EXPLANATION OF THE DRAWINGS

FIG. 1 is a perspective sectional view schematically illustrating a configuration of a solid-state battery in which a circuit is provided on a main surface according to an embodiment of the present invention.

FIGS. 2A to 2C are perspective views schematically illustrating a configuration of a solid-state battery in which a circuit is provided on a main surface according to an embodiment of the present invention.

FIGS. 3A to 3D are circuit diagrams (FIG. 3A: protective circuit, FIG. 3B: charge control circuit, FIG. 3C: temperature control circuit, FIG. 3D: output compensation circuit) of a battery peripheral circuit provided on a main surface of a solid-state battery.

FIGS. 4A to 4C are circuit diagrams (FIG. 4A: charge control/protective circuit, FIG. 4B: charge control/protection/output stabilization power supply circuit, FIG. 4C: charge control/protection/output stabilization power supply/output compensation circuit) in which a plurality of battery peripheral circuits provided on a main surface of a solid-state battery are combined.

FIG. 5 is a perspective view schematically illustrating a configuration of a packaged solid-state battery in which a covering insulating layer is provided on a main surface on which a circuit according to an embodiment of the present invention is provided.

FIG. 6 is a perspective view schematically illustrating a configuration of a packaged solid-state battery in which a covering insulating layer is provided on a surface other than a side surface on which an external electrode according to an embodiment of the present invention is provided.

FIG. 7 is a perspective view schematically illustrating a configuration of a packaged solid-state battery in which a covering insulating layer is provided so as to cover a portion other than a substrate mounting portion of the external terminal according an the embodiment of the present invention.

FIGS. 8A to 8C are process sectional views schematically illustrating a process of obtaining the solid-state battery illustrated in FIG. 6 in the present invention by packaging.

FIGS. 9A to 9C are process sectional views schematically illustrating a process of obtaining the solid-state battery illustrated in FIG. 7 in the present invention by packaging.

### DETAILED DESCRIPTION OF THE INVENTION

Hereinafter, the solid-state battery of the present invention will be described in detail. Although the description will be made with reference to the drawings as necessary, the illustrated contents are only schematically and exemplarily illustrated for the understanding of the present invention, and appearances, dimensional ratios, and the like may be different from actual ones.

The term “sectional view” used in the present specification is based on a form when viewed from a direction substantially perpendicular to a thickness direction based on a stacking direction of the layers constituting the solid-state battery (to put it briefly, a form in a case of being cut along a plane parallel to the thickness direction). The vertical direction and horizontal direction used directly or indirectly in the present specification correspond to a vertical direction and a horizontal direction in the drawings, respectively. Unless otherwise specified, the same reference numerals or symbols indicate the same members/portions or the same semantic contents. In one preferred aspect, it can be considered that a vertical downward direction (that is, a direction in which gravity acts) corresponds to a “downward direction”/“bottom side” and the opposite direction corresponds to an “upward direction”/“top side”.

The “solid-state battery” referred to in the present application refers to a battery whose constituent elements are composed of a solid in a broad sense, and refers to a battery in which each of the constituent elements formed of a solid is integrated with each other in a narrow sense. In a preferred aspect, the solid-state battery of the present invention is a stacked solid-state battery configured such that layers constituting a battery constituent unit are stacked on each other, and preferably such layers are formed of an integrally sintered body. The “solid-state battery” includes not only a so-called “secondary battery” capable of repeating charging and discharging but also a “primary battery” capable of only discharging. In a preferred aspect of the present invention, the “solid-state battery” is a secondary battery. The “secondary battery” is not excessively limited by the name, and may include, for example, a power storage device and the like.

Hereinafter, first, a basic configuration of the solid-state battery of the present invention will be described. The configuration of the solid-state battery described here is merely an example for understanding the invention, and does not limit the invention.

[Basic Configuration of Solid-State Battery]

The solid-state battery includes a solid-state battery laminate including at least one battery constituent unit including a positive electrode layer, a negative electrode layer, and a solid electrolyte layer interposed therebetween along a stacking direction.

In the solid-state battery, each layer constituting the solid-state battery is formed by firing, and a positive electrode layer, a negative electrode layer, a solid electrolyte, and the like form a fired layer. Preferably, the positive electrode layer, the negative electrode layer, and the solid electrolyte are each fired integrally with each other, and therefore the solid-state battery laminate forms an integrally sintered body.

The positive electrode layer is an electrode layer containing at least a positive electrode active material. The positive electrode layer may further include a solid electrolyte and/or a positive electrode current collecting layer. In a preferred aspect, the positive electrode layer includes a sintered body including at least positive electrode active material particles, solid electrolyte particles, and a positive electrode current collecting layer. On the other hand, the negative electrode layer is an electrode layer containing at least a negative electrode active material. The negative electrode layer may further include a solid electrolyte and/or a negative electrode current collecting layer. In a preferred aspect, the negative electrode layer includes a sintered body including at least negative electrode active material particles, solid electrolyte particles, and a negative electrode current collecting layer.

The positive electrode active material and the negative electrode active material are substances involved in the transfer of electrons in the solid-state battery. Ions move (conduct) between the positive electrode layer and the negative electrode layer via the solid electrolyte, and electrons are transferred, and thereby the charging and discharging are performed. The positive electrode layer and the negative electrode layer are particularly preferably layers capable of occluding and releasing lithium ions or sodium ions. That is, the all-solid-state secondary battery is preferably an all-solid-state secondary battery in which lithium ions or sodium ions move between the positive electrode layer and the negative electrode layer via the solid electrolyte to charge and discharge the battery.

(Positive Electrode Active Material)

Examples of the positive electrode active material contained in the positive electrode layer include at least one selected from the group consisting of a lithium-containing phosphate compound having a NASICON-type structure, a lithium-containing phosphate compound having an olivine-type structure, a lithium-containing layered oxide, and a lithium-containing oxide having a spinel-type structure. Examples of the lithium-containing phosphate compound having a NASICON-type structure include Li₃V₂(PO₄)₃. Examples of the lithium-containing phosphate compound having an olivine type structure include Li₃Fe₂(PO₄)₃, LiFePO₄, and/or LiMnPO₄. Examples of the lithium-containing layered oxide include LiCoO₂ and LiCo_{1/3}Ni_{1/3}Mn_{1/3}O₂. Examples of the lithium-containing oxide having a spinel-type structure include LiMn₂O₄ and/or LiNi_{0.5}Mn_{1.5}O₄.

Examples of the positive electrode active material capable of occluding and releasing sodium ions include at least one selected from the group consisting of a sodium-containing phosphate compound having a NASICON-type structure, a sodium-containing phosphate compound having an olivine-type structure, a sodium-containing layered oxide, and a sodium-containing oxide having a spinel-type structure.

(Negative Electrode Active Material)

Examples of the negative electrode active material contained in the negative electrode layer include at least one selected from the group consisting of an oxide containing at least one element selected from the group consisting of Ti, Si, Sn, Cr, Fe, Nb, and Mo, a graphite-lithium compound, a lithium alloy, a lithium-containing phosphate compound having a NASICON-type structure, a lithium-containing phosphate compound having an olivine-type structure, a lithium-containing oxide having a spinel-type structure, and the like. Examples of the lithium alloy include Li—Al. Examples of the lithium-containing phosphate compound having a NASICON-type structure include Li₃V₂(PO₄)₃ and/or LiTi₂(PO₄)₃. Examples of the lithium-containing phosphate compound having an olivine type structure include Li₃Fe₂(PO₄)₃ and/or LiCuPO₄. Examples of the lithium-containing oxide having a spinel-type structure include Li₄Ti₅O₁₂.

Examples of the negative electrode active material capable of occluding and releasing sodium ions include at least one selected from the group consisting of a sodium-containing phosphate compound having a NASICON-type structure, a sodium-containing phosphate compound having an olivine-type structure, and a sodium-containing oxide having a spinel-type structure.

Further, the positive electrode layer and/or the negative electrode layer may contain a conductive aid. Examples of the conductive aid contained in the positive electrode layer and the negative electrode layer include at least one kind of metal materials such as silver, palladium, gold, platinum, aluminum, copper, and nickel, and carbon. Although not particularly limited, copper is preferable in that it hardly reacts with the positive electrode active material, the negative electrode active material, the solid electrolyte material, and the like, and has an effect of reducing the internal resistance of the solid-state battery.

Further, the positive electrode layer and/or the negative electrode layer may contain a sintering aid. Examples of the sintering aid include at least one selected from the group consisting of lithium oxide, sodium oxide, potassium oxide, boron oxide, silicon oxide, bismuth oxide, and phosphorus oxide.

The thicknesses of the positive electrode layer and the negative electrode layer are not particularly limited, and may be, for example, 2 μm to 50 μm, particularly 5 μm to 30 μm, independently of each other.

(Solid Electrolyte)

The solid electrolyte is a material capable of conducting lithium ions or sodium ions. In particular, the solid electrolyte constituting a battery constituent unit in the solid-state battery forms a layer through which, for example, lithium ions or sodium ions can be conducted between the positive electrode layer and the negative electrode layer. The solid electrolyte may be provided at least between the positive electrode layer and the negative electrode layer. That is, the solid electrolyte may also exist around the positive electrode layer and/or the negative electrode layer so as to protrude from between the positive electrode layer and the negative electrode layer. Specific examples of the solid electrolyte include a lithium-containing phosphate compound having a NASICON structure, an oxide having a perovskite structure, and an oxide having a garnet-type structure or a garnet-type similar structure. Examples of the lithium-containing phosphate compound having a NASICON structure include LiₓM_{y}(PO₄)₃(1≤x≤2, 1≤y≤2, and M is at least one selected from the group consisting of Ti, Ge, Al, Ga, and Zr). Examples of the lithium-containing phosphate compound having a NASICON structure include Li_{1.2}Al_{0.2}Ti_{1.8}(PO₄)₃. Examples of the oxide having a perovskite structure include La_{0.55}Li_{0.35}TiO₃. Examples of the oxide having a garnet-type or garnet-type similar structure include Li₇La₃Zr₂O₁₂.

Examples of the solid electrolyte capable of conducting sodium ions include a sodium-containing phosphate compound having a NASICON structure, an oxide having a perovskite structure, and an oxide having a garnet-type structure or a garnet-type similar structure. Examples of the sodium-containing phosphate compound having a NASICON structure include NaₓM_{y}(PO₄)₃(1≤x≤2, 1≤y≤2, and M is at least one selected from the group consisting of Ti, Ge, Al, Ga, and Zr).

The solid electrolyte layer may contain a sintering aid. The sintering aid contained in the solid electrolyte layer may be selected from, for example, materials similar to the sintering aid that can be contained in the positive electrode layer and/or the negative electrode layer.

The thickness of the solid electrolyte layer is not particularly limited, and may be, for example, 1 μm to 15 μm, particularly 1 μm to 5 μm.

(Positive Electrode Current Collecting Layer/Negative Electrode Current Collecting Layer)

Although not an essential element of the electrode layer, the positive electrode layer and the negative electrode layer may include a positive electrode current collecting layer and a negative electrode current collecting layer, respectively. Each of the positive electrode current collecting layer and the negative electrode current collecting layer may have a form of a foil, and may have a form of a sintered body from the viewpoint of reducing the manufacturing cost of the solid-state battery by integral firing and reducing the internal resistance of the solid-state battery. As the positive electrode current collecting layer constituting the positive electrode current collecting layer and the negative electrode current collecting layer constituting the negative electrode current collecting layer, it is preferable to use a material having a high conductivity, and for example, it is preferable to use silver, palladium, gold, platinum, aluminum, copper, nickel, or the like. In particular, copper is preferable because it hardly reacts with the positive electrode active material, the negative electrode active material, the solid electrolyte material, and the like, and has an effect of reducing the internal resistance of the solid-state battery. Each of the positive electrode current collecting layer and the negative electrode current collecting layer may have an electrical connection portion for being electrically connected to the outside, and may be configured to be electrically connectable to the terminal. Each of the positive electrode current collecting layer and the negative electrode current collecting layer may have a form of a foil. It is preferable that the positive electrode current collecting layer and the negative electrode current collecting layer each have an integrally sintered form from the viewpoint of improving electron conductivity by integral sintering and reducing manufacturing cost. When the positive electrode current collecting layer and the negative electrode current collecting layer have a form of a sintered body, for example, the positive electrode current collecting layer and the negative electrode current collecting layer may be formed of a sintered body containing a conductive aid and a sintering aid. The conductive aid that is contained in the positive electrode current collecting layer and the negative electrode current collecting layer may be selected from, for example, materials similar to the conductive aid that can be contained in the positive electrode layer and/or the negative electrode layer. The sintering aid that is contained in the positive electrode current collecting layer and the negative electrode current collecting layer may be selected from, for example, materials similar to the sintering aid that can be contained in the positive electrode layer and/or the negative electrode layer.

The thicknesses of the positive electrode current collecting layer and the negative electrode current collecting layer are not particularly limited, and may be, for example, 1 μm to 5 μm, particularly 1 μm to 3 μm, independently of each other.

(Insulating Layer)

The insulating layer can be formed between one battery constituent unit and the other battery constituent unit adjacent to each other along the stacking direction, and is for avoiding movement of ions between the adjacent battery constituent units and preventing excessive occluding and releasing of ions. The insulating layer refers to a material that does not conduct electricity in a broad sense, that is, a layer including a non-conductive material, and refers to a layer including an insulating material in a narrow sense. Although not particularly limited, the insulating layer may be formed of, for example, a glass material, a ceramic material, or the like. For example, a glass material may be selected as the insulating layer. Although not particularly limited, examples of the glass material include at least one selected from the group consisting of soda lime glass, potash glass, borate glass, borosilicate glass, barium borosilicate glass, zinc borate glass, barium borate glass, bismuth borosilicate glass, bismuth zinc borate glass, bismuth silicate glass, phosphate glass, aluminophosphate glass, and zinc phosphate glass. Examples of the ceramic material include at least one selected from the group consisting of alumina, zirconia, spinel, and forsterite.

(End-Face Electrode)

The solid-state battery is generally provided with an end-face electrode. In particular, an end-face electrode is provided on a side surface of the solid-state battery. More specifically, an end-face electrode on the positive electrode side connected to the positive electrode layer and an end-face electrode on the negative electrode side connected to the negative electrode layer are provided. Such an end-face electrode preferably contains a material having high conductivity. The specific material of the end-face electrode is not particularly limited, and may be at least one selected from the group consisting of silver, gold, platinum, aluminum, copper, tin, and nickel.

[Circuit for Solid-State Battery]

The circuit for the solid-state battery is preferably a circuit that controls the solid-state battery. As will be described later, the circuit for the solid-state battery is provided on the main surface of the solid-state battery to be controlled. For example, a circuit for a solid-state battery includes an active element, a passive element, and/or a wiring pattern and controls repeated operations of charging and discharging in the solid-state battery. Such a circuit may be a protective circuit, a charge and discharge control circuit, and/or a temperature control circuit. The circuit wiring may be connected to the positive and negative electrodes of the solid-state battery, or may be connected to an electrode outside the solid-state battery.

(Protective Circuit)

The protective circuit is for limiting an input current or an output current to prevent overdischarge, overcharge, overcurrent and/or overheating of the solid-state battery, and the like. Specifically, the protective circuit controls charging and discharging of the solid-state battery by stopping charging when the solid-state battery is overcharged, stopping discharging when the solid-state battery is overdischarged, and/or stopping large current discharging when the solid-state battery is short-circuited.

(Charge and Discharge Control Circuit)

The charge and discharge control circuit is for controlling charge and discharge of the solid-state battery. Specifically, at the time of charging, the charge control circuit controls charging of the solid-state battery. On the other hand, at the time of discharging, the discharge control circuit controls discharging to an electronic device or the like on which the solid-state battery is mounted.

(Temperature Control Circuit)

The temperature control circuit is for controlling the temperature of the solid-state battery. Specifically, since the ambient temperature of the battery is closely related to the charge-discharge efficiency, the solid-state battery is controlled to an appropriate temperature so as to improve the charge-discharge efficiency.

(Output Compensation Circuit)

The output compensation circuit is for controlling the internal impedance of the solid-state battery. Specifically, since the internal impedance in the solid-state battery is closely related to the battery voltage, the internal impedance of the solid-state battery is kept low so as to alleviate the decrease in the battery voltage.

(Output Stabilization Power Supply Circuit)

The output stabilization power supply circuit is for controlling the output voltage and/or the output current of the direct current such that the output voltage and/or the output current always have a constant value. Specifically, with respect to power supplied from the power supply to the load, the output stabilization power supply circuit controls a load voltage.

(Input/Output Terminal Electrode)

The input/output terminal electrode (the input terminal electrode and/or the output terminal electrode) is for connecting a circuit for the solid-state battery to the positive and negative electrode of the solid-state battery and/or an electrode outside the solid-state battery. The input/output terminal electrode is provided on the main surface and/or the side surface of the solid-state battery. Such an input/output terminal electrode preferably contains a material having high conductivity. The specific material of the input/output terminal electrode is not particularly limited, and may be at least one selected from the group consisting of silver, gold, platinum, aluminum, copper, tin, and nickel.

(External Terminal)

In a surface mount type solid-state battery, an external terminal for mounting is generally provided. In particular, the external terminal is provided so as to be in contact with the end-face electrode and the input/output terminal electrode of the solid-state battery, and is provided so as to extend to the mounting surface of the solid-state battery. As such an external terminal, it is preferable to use a material having high conductivity. The material of the external terminal may be the same as that of the end-face electrode and/or the input/output terminal electrode.

[Features of Solid-State Battery of Present Invention]

The solid-state battery of the present invention is a more compact solid-state battery suitable for surface mounting. In particular, the solid-state battery of the present invention is characterized in that a circuit for the solid-state battery is provided in the solid-state battery itself.

Specifically, in the solid-state battery of the present invention, a main surface of the solid-state battery is a circuit forming surface, and a circuit for the solid-state battery is provided on the main surface thereof. In other words, the main surface of the solid-state battery is a support surface that supports the circuit for controlling the solid-state battery. When the circuit is provided on the surface itself forming the solid-state battery as described above (preferably, when the circuit is provided so as to extend on its face), it is not necessary to separately provide a circuit for the solid-state battery on a substrate, and a more compact solid-state battery can be obtained. In addition, the wiring distance between the solid-state battery and the circuit can be minimized, and the electrical loss can be reduced. In the solid-state battery of the present invention, since the circuit and the solid-state battery are integrated with each other with the solid-state battery surface interposed therebetween, heat from the circuit is easily transferred to the solid-state battery, and an effect that the charging efficiency of the battery can be improved due to the heat can also be exhibited.

The “main surface” referred to in the present application refers to a surface having a normal line in the stacking direction of the electrode layers in the solid-state battery. Preferably, the main surface is planar (that is, preferably, the circuit is provided directly on the plane that forms the solid-state battery). The circuit for the solid-state battery may be provided on at least one main surface, or may be provided on both opposing main surfaces. In addition, the “circuit forming surface” referred to in the present application means that the solid-state battery itself has a surface contributing to circuit formation in a broad sense, and means that the surface has battery insulation properties in a narrow sense. For example, in a case where a circuit is provided on such a surface, it means that the surface has electronic insulation properties so that voltage fluctuation or the like does not occur in the circuit.

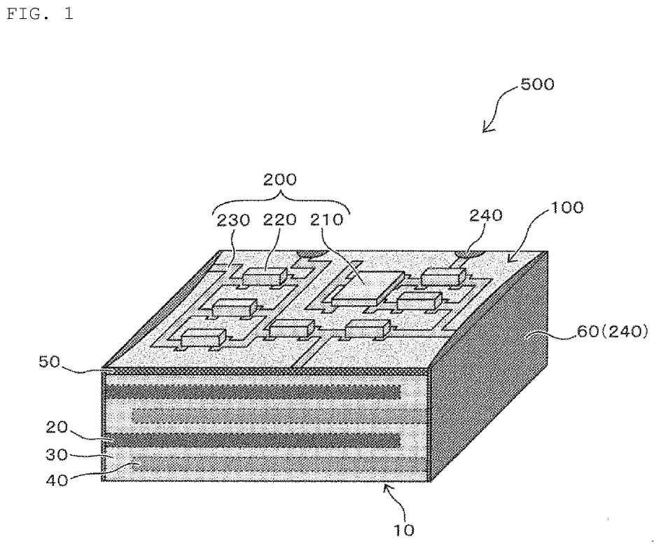

In the exemplary aspect illustrated in FIG. 1, a solid-state battery 500 has at least a feature in that a circuit 200 is provided on a main surface 100. That is, in the present invention, an active element, a passive element, and/or an auxiliary element constituting a circuit for a solid-state battery are provided in the solid-state battery. In particular, the circuit 200 for controlling the solid-state battery is provided so as to extend on a main surface of the solid-state battery (for example, a plane of the solid-state battery). As illustrated in the drawing, the circuit 200 may be provided in such a form as to be directly attached to the main surface 100 of the solid-state battery 500. Examples of the active element of the circuit include at least one selected from the group consisting of an IC, a transistor, a diode, an operational amplifier, and the like. Examples of the passive element of the circuit include at least one selected from the group consisting of a resistor, a coil, a capacitor, and the like. Examples of the auxiliary element of the circuit include at least one selected from the group consisting of a connector, a terminal, wiring, a wire material, and the like. Such a circuit element may have a chip form. When the circuit is provided along the main surface of the solid-state battery as described above, heat from the circuit is easily transferred to the solid-state battery as a whole, and the charging efficiency of the battery is more easily improved due to the heat.

The solid-state battery 500 has a package structure including a circuit 200 (that is, active element 210, passive element 220, and/or wiring pattern 230) for the solid-state battery. In such a solid-state battery 500, the circuit 200 is provided on the main surface 100. At least one circuit 200 is provided on the main surface 100, and a plurality of circuits may be provided.

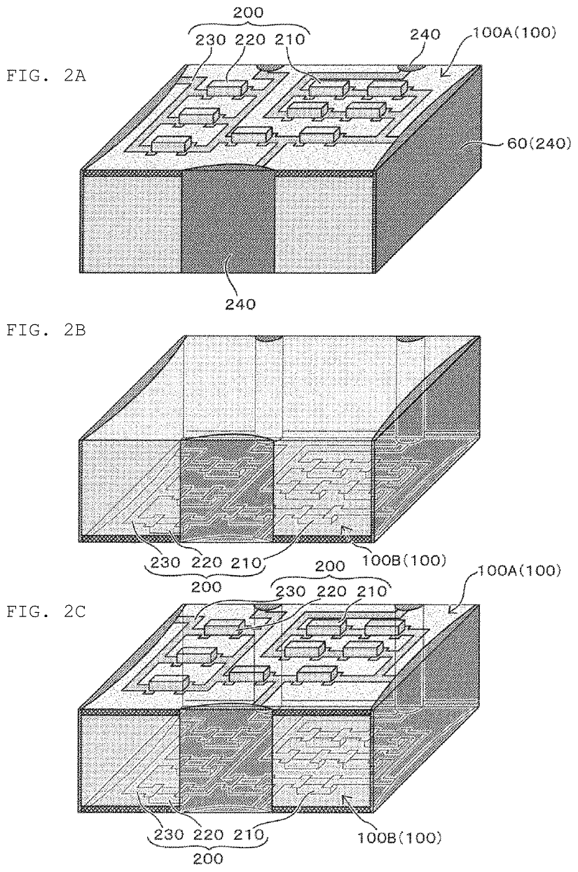

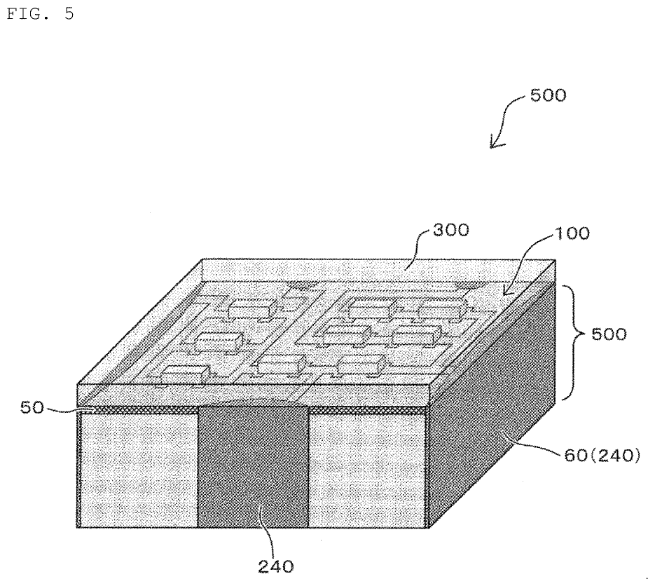

When the solid-state battery of the present invention is a surface-mounted product, a circuit may be provided on the other main surface 100A facing a main surface 100B on the mounting surface side of the solid-state battery 500 (FIG. 2A), or a circuit may be provided on the main surface 100B on the mounting surface side (FIG. 2B). In the aspect of FIG. 2A, the circuit 200 is provided on the main surface 100A on the non-mounting surface side that is not the mounting surface side in the solid-state battery. The term “mounting surface side” as used herein means that the solid-state battery is positioned on the proximal side relative to the substrate when the solid-state battery is surface-mounted on the substrate. Therefore, the “main surface on the non-mounting surface side” refers to a main surface located relatively on the distal side with respect to the substrate when the solid-state battery is surface-mounted on the substrate. When the circuit 200 is provided with respect to the main surface 100A on the non-mounting surface side, typically, the circuit 200 is provided with respect to a main surface on a side different from the main surface side on which the electrode directly connected to the external substrate is positioned at the time of mounting. When the circuit is provided on the main surface on the non-mounting surface side as described above, the “covering insulating film covering the circuit” is easily provided because there is no “electrode directly connected to the substrate” (for the “covering insulating film”, refer to “300” in FIG. 5 described later). In addition, since the circuit is arranged on the relatively distal side with respect to the external substrate, an inconvenient interaction between the external substrate and the circuit 200 is easily avoided. In terms of increasing the installation area of the circuit, the circuits may be provided on both main surfaces (that is, main surface 100A and main surface 100B) of the solid-state battery (FIG. 2C).

In a preferred aspect, the circuit for the solid-state battery includes at least one selected from the group consisting of a protective circuit, a charge control circuit, a temperature control circuit, and an output compensation circuit. In the exemplary aspect illustrated in FIG. 1, the circuit 200 on the main surface 100 of the solid-state battery 500 is a protective circuit, a charge control circuit, a temperature control circuit, an output compensation circuit, and/or an output stabilization power supply circuit.

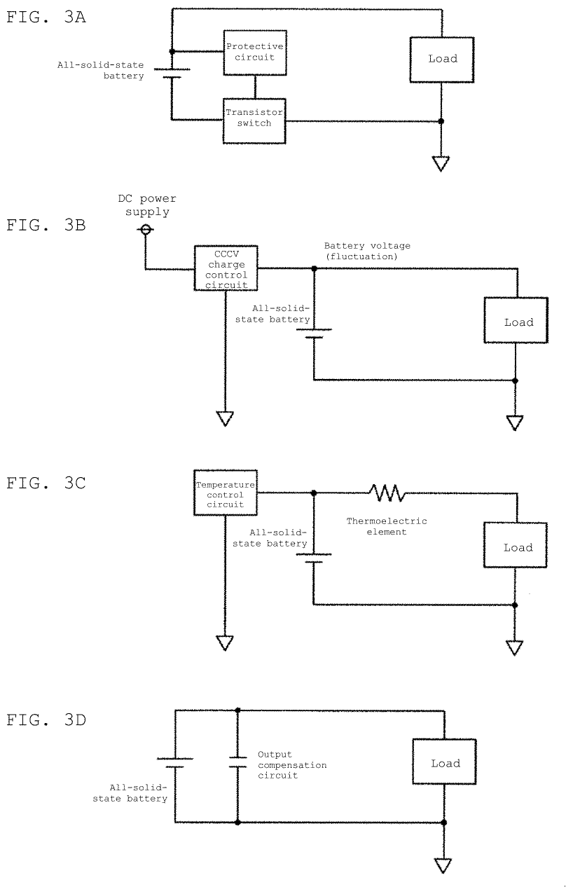

By using the circuit 200 as a protective circuit, overdischarge, overcharge, overcurrent and/or overheating of the solid-state battery can be prevented. FIG. 3A illustrates an example of a circuit diagram when the circuit 200 provided on the main surface 100 of the solid-state battery 500 serves as a protective circuit. Although it is merely an example description, in such a protective circuit, a predetermined voltage or current is controlled so as not to be excessive.

By using the circuit 200 as a charge control circuit, charging and discharging of the solid-state battery can be controlled. FIG. 3B illustrates an example of a circuit diagram when the circuit 200 provided on the main surface 100 of the solid-state battery 500 serves as a charge control circuit. Although it is merely an example description, such a charge control circuit controls the voltage and/or current between the solid-state battery and the power supply so as to obtain a desired constant current constant voltage (CCCV).

By using the circuit 200 as a temperature control circuit, the solid-state battery can be controlled to an appropriate temperature (for example, about 60° C.) so as to improve the charge-discharge efficiency. FIG. 3C illustrates an example of a circuit diagram when the circuit 200 provided on the main surface 100 of the solid-state battery 500 serves as a temperature control circuit. Although it is merely an example description, in a case where the temperature of the solid-state battery is controlled by such a temperature control circuit, the temperature of the solid-state battery is detected by a temperature detection unit such as a thermocouple or a thermistor, and power is supplied to the thermoelectric element via the temperature control circuit on the basis of temperature information obtained thereby, and the battery may be heated and/or cooled.

By using the circuit 200 as an output compensation circuit, the internal impedance of the solid-state battery 500 can be suppressed to be low, and the decrease in the battery voltage can be alleviated. FIG. 3D illustrates an example of a circuit diagram when the circuit 200 provided on the main surface 100 of the solid-state battery 500 serves as an output compensation circuit.

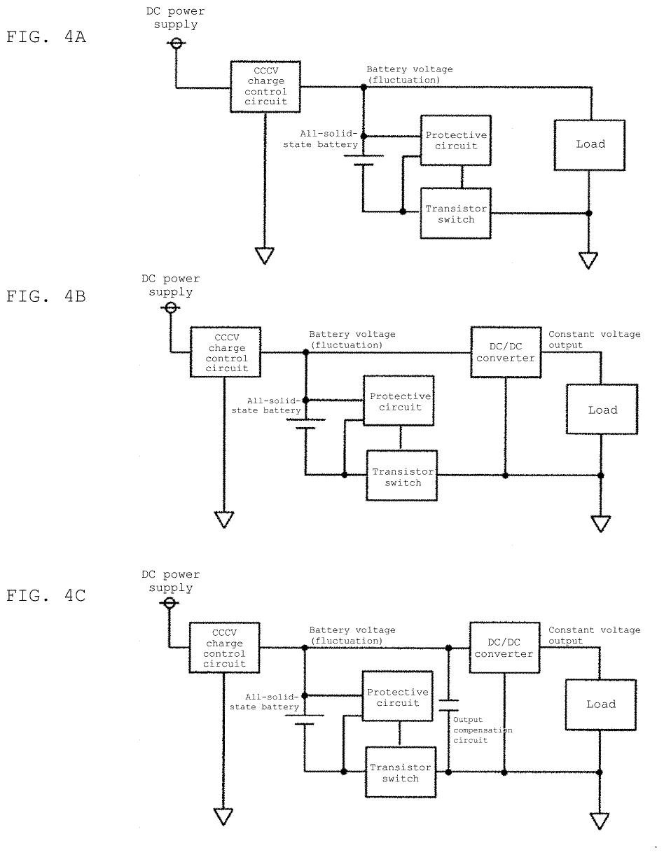

The circuit may be provided so as to have a single function, but may be provided in combination so as to have a plurality of functions. For example, by providing a plurality of sub-circuits in combination, characteristics of each circuit can be imparted to control of the solid-state battery. As illustrated exemplary aspects, FIG. 4A illustrates a combination of a charge control circuit and a protective circuit, FIG. 4B illustrates a combination of a charge control circuit, a protective circuit, and an output stabilization power supply circuit, and FIG. 4C illustrates a combination of a charge control circuit, a protective circuit, an output stabilization power supply circuit, and an output compensation circuit. Note that the output stabilization power supply circuit may incorporate a DC-DC converter.

In a preferred aspect, an input/output terminal electrode is formed on a main surface and/or a side surface of the solid-state battery. In the exemplary aspect illustrated in FIG. 1, input/output terminal electrodes 240 are provided on the main surface 100 and side surfaces of the solid-state battery 500 so as to extend from one main surface to the other main surface of the solid-state battery 500 via the side surfaces. Further, the circuit 200 may be connected to the input/output terminal electrode 240 via the wiring pattern 230. The input/output terminal electrodes 240 are preferably formed in the same manner as end-face electrodes 60 of the positive and negative electrodes from the viewpoint of manufacturing cost. The input/output terminal electrode 240 may also serve as the end-face electrode 60. When there is a circuit to be connected to other than the end-face electrode 60, an independent input/output terminal electrode 240 may be formed other than the end-face electrode 60.

The end-face electrode and the input/output terminal electrode may have any form as long as they contribute to electrical connection between the solid-state battery and the substrate. Since it contributes to electrical connection, it can be said that the end-face electrode and the input/output terminal electrode are conductive portions connecting the solid-state battery and the substrate. Such conductive portions may at least have the form of wiring layers and/or lands, and the like in some parts. The term “land” as used herein refers to a terminal portion or a connection portion for electrical connection provided on one and/or both of the main surfaces of the solid-state battery, and may be, for example, a square land or a round land.

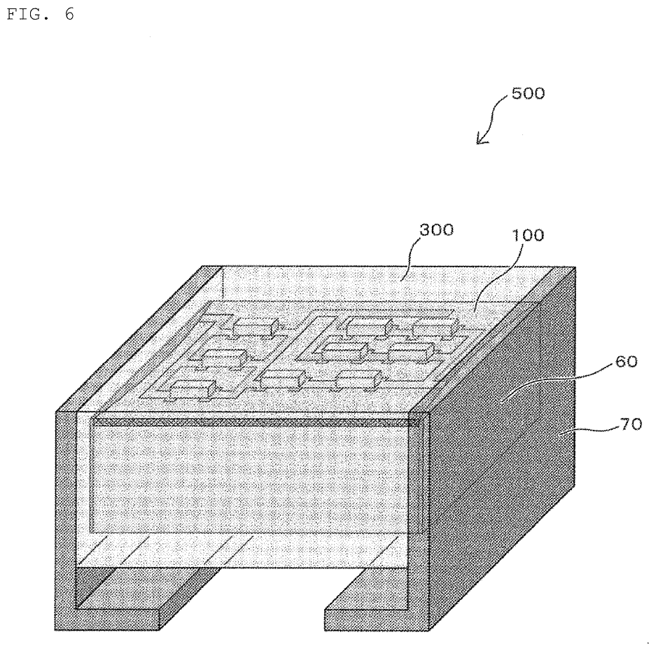

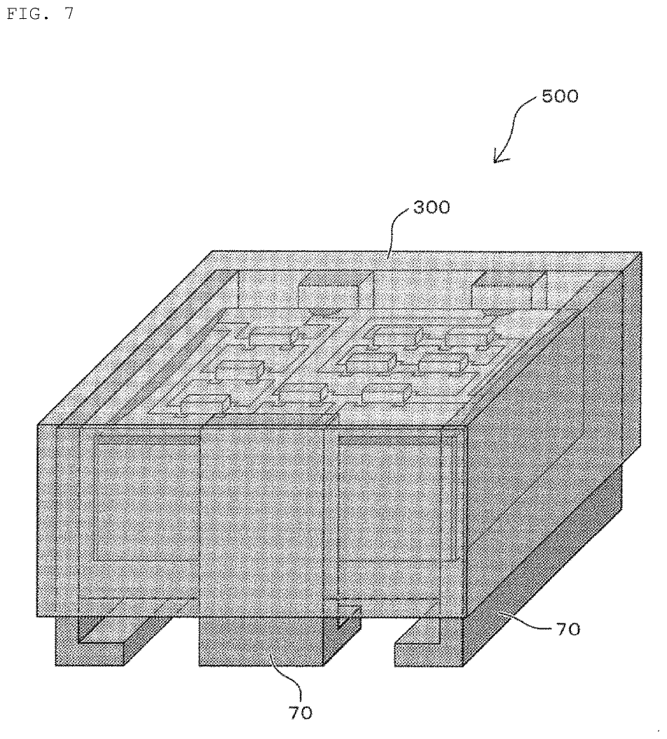

With such a configuration, it is not necessary to provide a terminal for the solid-state battery on the substrate to be mounted, and the solid-state battery can be more suitable for mounting. From the viewpoint of mounting the solid-state battery on the substrate, the input/output terminal electrode may be a surface mount type terminal. In the exemplary aspect illustrated in FIG. 5, the input/output terminal electrode 240 (60) may extend to reach a main surface of the solid-state battery on which no circuit is provided. For example, with respect to such an input/output terminal electrode, an external terminal 70 extending so as to extend to the main surface of the solid-state battery on which the circuit is not provided can be provided to form a surface mount type terminal as illustrated in FIGS. 6 and 7. As illustrated in the drawing, the external terminal 70 may have a form in which an end portion thereof (particularly, a lower end portion or a bottom end portion) is bent. Various structures of the external terminal can be taken, but a structure in which a terminal electrode directly formed on a surface on a mounting surface side of the solid-state battery is exposed as an electrode for substrate connection is preferable. With such a structure, the solid-state battery can have a smaller and shorter structure. The material of the external terminal is not particularly limited, but may be the same as the material of the end-face electrode and the input/output terminal electrode.

The main surface forming layer forming the main surface in the solid-state battery of the present invention may be an insulating layer having at least electronic insulation properties. The main surface forming layer is a layer that is positioned at the uppermost layer and/or the lowermost layer of the battery component of the solid-state battery in the stacking direction and forms the main surface of the solid-state battery. In the exemplary aspect illustrated in FIG. 1, the main surface forming layer 50 forming the main surface 100 of the solid-state battery 500 is an insulating layer exhibiting electronic insulation properties. Due to the presence of such a main surface forming layer, the main surface 100 of the solid-state battery 500 easily becomes a more suitable circuit forming surface.

The material constituting the main surface forming layer is preferably a layer excellent in the insulating properties, rigidity, electrode adhesion strength, and/or moisture permeation preventing property. The main surface forming layer may be made of the same material as the insulating layer, and for example, a glass material and a ceramic material are preferably used. The glass material and the ceramic material may be selected from the same materials as those that can be contained in the insulating layer.

In a preferred aspect, the main surface forming layer is an insulating layer having ion insulation properties. Since the main surface forming layer has the ion insulation properties, it is possible to more suitably suppress fluctuation of a circuit voltage caused by ion conduction inside the solid-state battery.

In a more preferred aspect, the main surface forming layer may contain a ceramic. That is, the main surface forming layer may be a ceramic insulating layer. When the main surface forming layer contains ceramics, the electronic insulation properties and ion insulating properties can be more effectively imparted to the main surface forming layer. In addition, the rigidity of the main surface forming layer can be increased, and a circuit can be more easily formed on the surface. Further, moisture permeation preventing property can be imparted to the outermost surface of the solid-state battery, and deterioration of battery performance can be effectively prevented.

In a preferred aspect, a solid-state battery includes a solid-state battery laminate including a positive electrode layer, a negative electrode layer, and a solid electrolyte layer interposed between the positive electrode layer and the negative electrode layer, and the main surface forming layer of the solid-state battery forms an integrally sintered body with the solid-state battery laminate. According to the exemplary aspect illustrated in FIG. 1, the solid-state battery 500 includes a solid-state battery laminate in which a positive electrode layer 20, a solid electrolyte layer 30, and a negative electrode layer 40 are provided in this order in a sectional view (that is, section 10), and the solid-state battery laminate and the main surface forming layer 50 are integrally sintered. A co-sintered body may be formed at an interface between the solid-state battery laminate and the main surface forming layer due to integral sintering.

By integrally sintering the solid-state battery laminate and the main surface forming layer, although a material having relatively low adhesiveness to the solid-state battery laminate (for example, ceramics) is used for the main surface forming layer as compared with other materials, it is easy to have a structure in which the constituent materials in the solid-state battery are in firmly close contact (i.e., direct contact) with each other. In addition, the main surface forming layer having a circuit can be integrally formed as a solid-state battery, and steps such as bonding of the solid-state battery and the circuit board can be reduced.

In a preferred aspect, the solid-state battery is a packaged solid-state battery. The “packaged solid-state battery” refers to a solid-state battery protected from an external environment. Preferably, the solid-state battery of the present invention protected from such an external environment is packaged so as to be suitable for substrate mounting, particularly packaged so as to be suitable for surface mounting. In a preferred aspect, the battery of the present invention is a surface mount device (SMD) type battery.

Examples of the solid-state battery protected from the external environment include a solid-state battery sealed so that water vapor from the external environment does not enter the inside of the solid-state battery (by way of example only, refer to FIGS. 5 to 7). Examples of the solid-state battery packaged so as to be suitable for surface mounting include a solid-state battery (refer to, for example, FIG. 1) in which a terminal extended portion (for example, a socket terminal, a pressure contact terminal, or the like) is provided on the solid-state battery side, and a solid-state battery in which an external terminal forms a wide surface with respect to a substrate so as to be easily mounted on the substrate (refer to, for example, FIGS. 6 and 7).

In a preferred aspect, the covering insulating layer is provided so as to cover the main surface on which the circuit is provided. In the exemplary aspect illustrated in FIG. 5, in the solid-state battery 500, a covering insulating layer 300 is provided so as to cover the circuit. Accordingly, the circuit can be suitably protected. In addition, due to the presence of the covering insulating layer 300, it is also possible to further improve the mutual integrity between the solid-state battery and the circuit thereon as a battery package product.

The covering insulating layer 300 may be a resin layer. That is, the covering insulating layer 300 may include a resin material, and the resin material may form a base material of the layer. As can be seen from the illustrated aspect, it means that the main surface of the solid-state battery is sealed with the resin material of the covering insulating layer 300. The covering insulating layer 300 made of such a resin material can contribute to more suitable water vapor transmission preventing property.

The material of the covering insulating layer may be any type as long as it exhibits the insulating properties. For example, when the covering insulating layer contains a resin, the resin may be either a thermosetting resin or a thermoplastic resin. Although not particularly limited, examples of the specific resin material of the covering insulating layer include an epoxy-based resin, a silicone-based resin, and/or a liquid crystal polymer. Although it is merely an example, the thickness of the covering insulating layer may be 30 μm to 1000 μm, and is, for example, 50 μm to 300 μm.

The covering insulating layer may be a layer provided so as to cover at least a part of the main surface of the solid-state battery on which the circuit is provided. Further, the covering insulating layer may be a layer that covers at least the main surface on which the circuit is provided and covers the other surface. In a preferred aspect, as in the exemplary aspect illustrated in FIG. 5, the covering insulating layer 300 is provided only on the main surface 100. With such a configuration, the input/output terminal electrode 240 can be provided on the side surface of the solid-state battery 500 other than the side surface on which the end-face electrode 60 is provided while protecting the circuit provided on the main surface 100 from water vapor or the like, and more terminal extended portions can be provided.

For example, the covering insulating layer may be provided so as to cover a surface other than the side surface on which the end-face electrode is provided. In a preferred aspect, as in the exemplary aspect illustrated in FIG. 6, in addition to the main surface 100 on which the circuit is provided, the covering insulating layer 300 is also provided on a surface (that is, surfaces other than the side surface on which the external electrode 70 is provided) other than the side surface on which the end-face electrode 60 is provided. With such a configuration, the solid-state battery 500 can be covered with the covering insulating layer 300 more widely, and the water vapor transmission prevention can be more suitably achieved for the solid-state battery 500.

Further, the covering insulating layer may be provided so as to cover the battery package product provided with the external terminals. As in the exemplary aspect illustrated in FIG. 7, in the solid-state battery 500, the covering insulating layer 300 is provided so as to cover portions overall other than the board mounting portion of the external terminals 70. With such a configuration, the overall solid-state battery 500 can be covered with the covering insulating layer 300, and in particular, entry of water vapor through the external terminals 70 can be prevented. In addition, since the external terminals 70 can be provided on any side surface of the solid-state battery 500, more circuits 200 can be connected to the substrate.

The covering insulating layer 300 may contain a filler. When the covering insulating layer 300 is made of a resin material, an inorganic filler is preferably dispersed in such a resin material. The filler is preferably mixed in the covering insulating layer to be combined and integrated with a base material (for example, a resin material) of the covering insulating layer. The shape of the filler is not particularly limited, and may be granular, spherical, needle, plate, fiber, and/or amorphous. The size of the filler is also not particularly limited, and may be 10 nm to 100 μm. Examples of the material of the filler include metal oxides such as silica, alumina, titanium oxide, and zirconium oxide, minerals such as mica, and/or glass, but are not limited thereto.

The filler is preferably a water vapor transmission preventing filler. In a preferred aspect, the covering insulating layer contains a water vapor transmission preventing filler in the resin material. As a result, the covering insulating layer is easily provided as a more suitable water vapor transmission preventing layer. The content of the water vapor transmission preventing filler contained in the resin material is preferably 50% by weight to 95% by weight, and may be, for example, 60% by weight to 95% by weight, or 70% by weight to 95% by weight, based on the total weight of the covering insulating layer, in order to more suitably prevent the transmission of water vapor.

In a preferred aspect, a covering inorganic film is additionally provided so as to cover the covering insulating layer. When the covering inorganic film is positioned on the covering insulating layer, the covering inorganic film may be provided so as to cover the main surface of the solid-state battery together with the covering insulating layer. That is, the covering inorganic film and the covering insulating layer may be stacked on the main surface of the solid-state battery.

The covering inorganic film preferably has a thin film form. Therefore, the thickness of the covering inorganic film as a covering member is smaller than the thickness of the covering insulating layer. The material of the covering inorganic film is not particularly limited as long as it contributes to the inorganic layer having a thin film form, and may be any of metal, glass, oxide ceramic, mixtures thereof, and the like. In a preferred embodiment, the covering inorganic film contains a metal component. That is, the covering inorganic film is preferably a metal thin film. Although it is merely an example, the thickness of the covering inorganic film may be 0.1 μm to 100 μm, and is, for example, 1 μm to 50 μm.

The covering inorganic film having a thin film form may be a plating film. In particular, depending on the manufacturing method, the covering inorganic film may be a dry plating film. Such a dry plating film is a film obtained by a vapor phase method such as physical vapor deposition (PVD) or chemical vapor deposition (CVD), and has a very small thickness on the nano order or the micron order. Such a thin dry plating film contributes to more compact packaging.

The dry plating film may include, for example, at least one metal component/metalloid component selected from the group consisting of aluminum (Al), nickel (Ni), palladium (Pd), silver (Ag), tin (Sn), gold (Au), copper (Cu), titanium (Ti), platinum (Pt), silicon/silicone (Si), SUS, and the like, an inorganic oxide, and/or a glass component. Since the dry plating film including such a component is chemically and/or thermally stable, a solid-state battery having excellent chemical resistance, weather resistance, heat resistance, and the like and further improved long-term reliability can be provided.

When the solid-state battery of the present invention is covered with the covering inorganic film with the covering insulating layer interposed therebetween, the covering insulating layer can also serve as a buffering material. Specifically, although expansion and shrinkage of the solid-state battery occurs due to charge and discharge, thermal expansion, or the like, the influence thereof does not directly reach the covering inorganic film, and the influence of the buffer effect can be alleviated by interposing the covering insulating layer. Therefore, the occurrence of cracks and the like is reduced with such a thin film like a covering inorganic film, and a more suitable water vapor barrier can be provided. This is particularly true when the covering insulating layer includes a resin material, and the covering insulating layer including a resin material can increase such a buffering effect.

When the solid-state battery of the present invention is covered with the covering inorganic film with the covering insulating layer interposed therebetween, the member contributing to the covering is the covering insulating layer and the covering inorganic thin film integrated with the covering insulating layer, so that the package size does not undesirably increase. That is, it is possible to provide a compact packaged product while preventing water vapor transmission. This means that the solid-state battery of the present invention can be provided as a battery having a high energy density in which the water vapor transmission is prevented.

As described above, the solid-state battery of the present invention can be mounted on a substrate such as a printed wiring board. For example, the solid-state battery can be surface-mounted through solder reflow or the like. From the above, it can be said that the packaged solid-state battery of the present invention is an SMD type battery.

The advantages of the solid-state battery described above can also be summarized as follows. Note that the following advantages are merely examples and are not limited, and there may be additional advantages.

By providing a circuit in the solid-state battery itself, the solid-state battery can be made more compact, and can be provided as a battery package product having a high energy density.

The wiring distance between the solid-state battery and the peripheral circuit can be shortened, the failure occurrence rate can be reduced in the middle of the circuit, and a highly reliable battery package product can be obtained.

A peripheral circuit including a multi-terminal electronic device can be integrated with high reliability, and a small module including a solid-state battery can be achieved.

The multi-terminals can be arranged in SMD-allowable lands at free positions on one plane. Therefore, the degree of freedom in designing the motherboard is improved, and the density can be increased.

By using a non-cleaning bonding material (bonding material that does not require flux cleaning after soldering) as a bonding material that is in direct contact with the battery, the solid-state battery can be mounted after electronic component mounting/cleaning in the manufacturing process. Therefore, the electronic component can be flux cleaned although the electronic component is bonded with a less expensive and highly reliable solder capable of increasing the mounting area in density. On the other hand, while the solid-state battery is necessarily bonded without washing, both the battery and the SMD component can be mounted in the package with an optimal bonding material.

Since a barrier layer that protects the solid-state battery from water vapor covers a wide area, characteristic deterioration due to water vapor in the external environment can be prevented.

[Method for Manufacturing Solid-State Battery]

The solid-state battery as an object of the present invention can be obtained by preparing a sintered laminate including a positive electrode layer, a negative electrode layer, a solid-state battery laminate having a solid electrolyte between the positive electrode layer and the negative electrode layer, and a main surface forming layer, and then passing through a process of forming a circuit on the main surface of the sintered laminate.

<<Method for Manufacturing Solid-State Battery>>

The solid-state battery can be manufactured by a printing method such as a screen printing method, a green sheet method using a green sheet, or a composite method thereof. That is, the solid-state battery of the present invention may be manufactured according to a known solid-state battery manufacturing method except for the main surface forming layer and the circuit formed on the main surface (therefore, as raw material substances such as a solid electrolyte, an organic binder, a solvent, an optional additive, a positive electrode active material, and a negative electrode active material described below, those used in the manufacturing of known solid batteries may be used).

Hereinafter, for better understanding of the present invention, one manufacturing method will be exemplified and described, but the present invention is not limited thereto. In addition, temporal matters such as the following description order are merely for convenience of description, and are not necessarily limited thereto.

(Forming of Pre-Sintered Laminate)

A solid electrolyte, an organic binder, a solvent, and optional additives are mixed to prepare a slurry. Next, green sheets for solid electrolytes having a thickness of about 10 μm after firing are obtained from the prepared slurry by green sheet molding.

A positive electrode active material, a solid electrolyte, a conductive aid, an organic binder, a solvent, and an optional additive are mixed to prepare a positive electrode paste. Similarly, a negative electrode active material, a solid electrolyte, a conductive aid, an organic binder, a solvent, and an optional additive are mixed to prepare a negative electrode paste.

A ceramic component, a glass component, an organic binder, a solvent, and an optional additive are mixed to prepare a paste for a main surface forming layer.

A positive electrode green sheet is obtained by printing a positive electrode paste on the solid electrolyte green sheet, and printing a current collecting layer and/or a negative layer as necessary. Similarly, a negative electrode green sheet is obtained by printing a negative electrode paste on the solid electrolyte green sheet, and printing a current collecting layer and/or a negative layer as necessary.

The paste for a main surface forming layer is printed to obtain a green sheet for a main surface forming layer.

The positive electrode green sheet and the negative electrode green sheet are alternately stacked to obtain a laminate.

A green sheet for a main surface forming layer is stacked on the uppermost layer and the lowermost layer of the laminate of the positive electrode green sheet and the negative electrode green sheet to obtain a pre-sintered laminate.

For example, an Ag-based sintering-type thick film paste is applied to one surface (one surface of the pre-sintered laminate) of the green sheet for a main surface forming layer to form a wiring pattern. The wiring pattern may be formed of an Ag paste on the main surface of the sintered solid-state battery.

Although this is merely one example and does not limit the present invention, a green sheet in a case of obtaining a main surface forming layer as a layer containing ceramics will be described in detail. The green sheet itself may be a green sheet-shaped member containing a ceramic component, a glass component, and an organic binder component. For example, the ceramic component may be an alumina powder (average particle size: about 0.5 to 10 μm), and the glass component may be a borosilicate glass powder (average particle size: about 1 to 20 μm). The organic binder component may be, for example, at least one or more components selected from the group consisting of a polyvinyl butyral resin, an acrylic resin, a vinyl acetate copolymer, polyvinyl alcohol, and a vinyl chloride resin. By way of example only, the green sheet may be 40% to 50% by weight alumina powder, 30% to 40% by weight glass powder, and 10% to 30% by weight organic binder component (by total weight of the green sheet). From another point of view, the green sheet may have a weight ratio of the solid component (50% to 60% by weight alumina powder and 40% to 50% by weight glass powder: based on the weight of the solid component) to the organic binder component, that is, a weight ratio of the solid component to the organic binder component of about 80 to 90:10 to 20. As the green sheet component, other components may be contained as necessary, and for example, a plasticizer that imparts flexibility to the green sheet, such as phthalate ester and/or dibutyl phthalate, a dispersant of ketones such as glycol, an organic solvent, and the like may be contained. The thickness itself of each green sheet may be about 30 μm to 500 μm.

(Forming of Battery Sintered Body)

The laminate before sintering is pressure-bonded and integrated, and then cut into a predetermined size. The obtained cut laminate is subjected to degreasing and firing. Thus, a sintered laminate is obtained. The laminate may be subjected to degreasing and firing before cutting, and then cut.

(Forming of End-Face Electrode and Input/Output Terminal Electrode)

The end-face electrode on the positive electrode side can be formed by applying a conductive paste to the positive electrode exposed side surface of the sintered laminate. Similarly, the end-face electrode on the negative electrode side can be formed by applying a conductive paste to the negative electrode exposed side surface of the sintered laminate. Similarly, the input/output terminal electrode can be formed by applying a conductive paste to the main surface and the side surface of the sintered laminate so as to be connected to the wiring pattern in the circuit. The circuit is connected to the input/output terminal electrode via the wiring pattern. The input/output terminal electrode may be formed identically or simultaneously with the end-face electrode, but when there is a plurality of circuits to be connected other than the end-face electrode, an independent input/output terminal electrode may be formed other than the end-face electrode.

When the end-face electrode and the input/output terminal electrode are provided so as to extend to the main surface of the sintered laminate where the circuit is not provided, it is preferable because it can be connected to the mounting land in a small area in the next process (more specifically, since the end-face electrode and the input/output terminal electrode provided so as to extend to the main surface of the sintered laminate have a folded portion on the main surface, such a folded part can be electrically connected to the mounting land). The components of the end-face electrode and the input/output terminal electrode can be selected from at least one selected from silver, gold, platinum, aluminum, copper, tin, and nickel.

The end-face electrode and the input/output terminal electrode are not limited to be formed after sintering of the laminate, and may be formed before firing and subjected to simultaneous sintering.

(Circuit Formation on Main Surface)

First, a bonding material is provided to the surface of the main surface forming layer (that is, the main surface) of the sintered laminate. The bonding material may be, for example, a metallic brazing agent, a solder, a conductive paste, or a nano paste. A peripheral circuit for the solid-state battery is then provided. More specifically, electronic components such as an active element, a passive element, and/or an auxiliary element necessary for the battery peripheral circuit are mounted at a predetermined position on the main surface. When such a desired mount is completed, the main surface is subjected to reflow soldering, and flux cleaning is performed. As described above, the main surface on which the circuit is formed is obtained.

Through the above steps, a desired solid-state battery can be finally obtained.

Regarding such a solid-state battery, there is an advantage that the terminal extended portion of the solid-state battery is relatively easy in terms of design and bonding process. In addition, as the solid-state battery becomes more compact, the area ratio of the package to the battery becomes smaller, but in the solid-state battery according to the present invention, this area can be extremely small, which can contribute to the compactness of a battery having a particularly small capacity.

«Packaging of Solid-State Battery>>

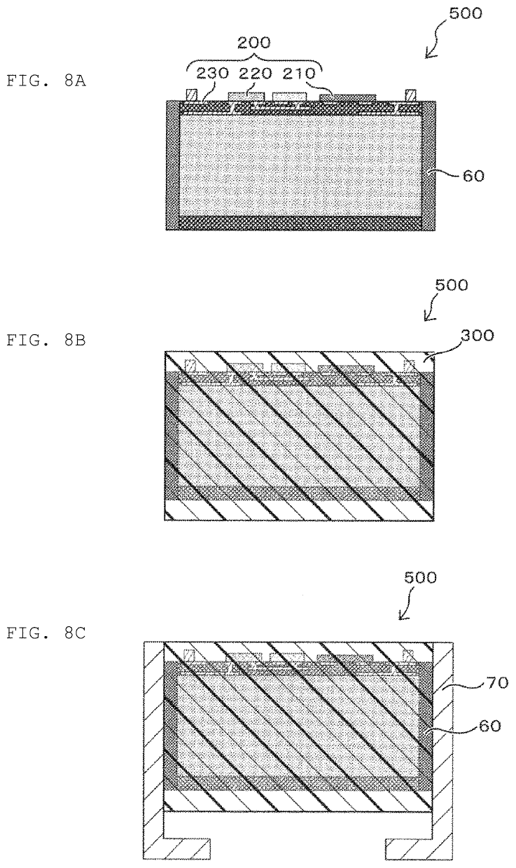

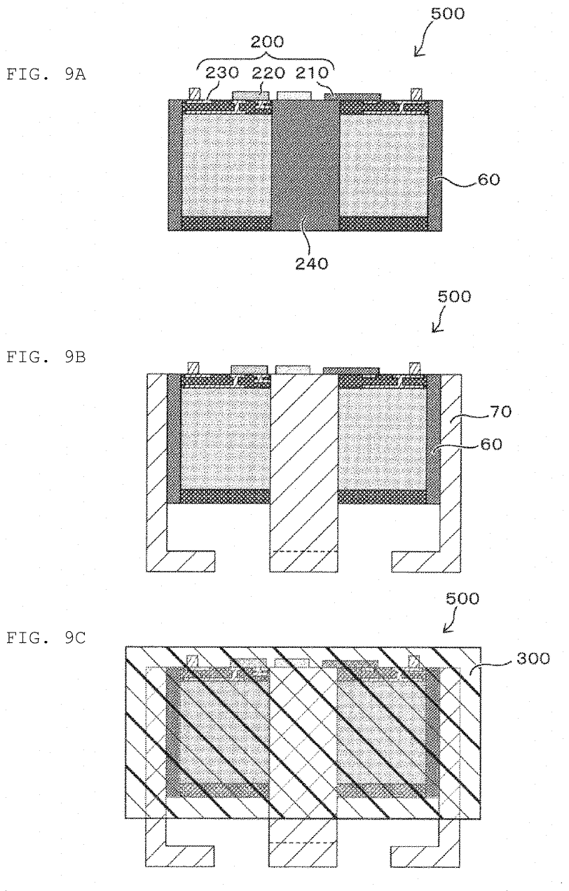

FIGS. 8A-8C and 9A-9C schematically illustrate a step of obtaining the solid-state battery of the present invention by packaging. The solid-state battery 500 obtained as described above is used for packaging, the solid-state battery 500 in FIG. 8A is provided with only the end-face electrode 60, and the solid-state battery 500 in FIG. 9A is provided with the end-face electrode 60 and an input/output terminal 240.

The aspect illustrated in FIGS. 8A to 8C will be described. First, as illustrated in FIG. 8B, in the solid-state battery 500, the covering insulating layer 300 is formed so as to cover a portion other than the side surface on which the end-face electrode 60 is formed. When the covering insulating layer is made of a resin material, a resin precursor is provided on a predetermined surface of the solid-state battery 500 and cured to mold the covering insulating layer. In a preferred embodiment, the covering insulating layer may be molded by applying pressure in a mold. Although it is merely an example, a covering insulating layer for sealing the solid-state battery on the support substrate may be molded through a compression mold. In a case of a resin material generally used in the mold, the form of the raw material of the covering insulating layer may be granular, and the type thereof may be thermoplastic. Such a molding is not limited to a die molding, and may be performed through polishing, laser processing, and/or a chemical treatment.

Next, as illustrated in FIG. 8C, the external terminal 70 is provided in the solid-state battery 500 obtained as described above. The external terminal 70 is provided such that the positive electrode layer and the negative electrode layer can be electrically connected to the substrate via the end-face electrode 60. In addition, the external terminal 70 is provided so that the circuit 200 can be mounted on the substrate via the end-face electrode 60. The external terminal 70 is preferably formed by, for example, sputtering or the like. Although not particularly limited, the external terminal is preferably formed of at least one selected from silver, gold, platinum, aluminum, copper, tin, and nickel.

The aspect illustrated in FIGS. 9A to 9C will be described. First, as illustrated in FIG. 9B, external terminal 70 is provided in solid-state battery 500. The external terminal 70 is provided such that the positive electrode layer and the negative electrode layer can be electrically connected to the substrate via the end-face electrode 60. In addition, the external terminal 70 is provided so that the circuit 200 can be mounted on the substrate via the end-face electrode 60 and the input/output terminal 240. The external terminal 70 may be formed by a method similar to the aspect illustrated in FIG. 8C.

Next, as illustrated in FIG. 9C, in the solid-state battery 500, the covering insulating layer 300 is formed so as to cover a portion other than the substrate mounting portion of the external terminal 70. The covering insulating layer 300 may be formed by a method similar to the aspect illustrated in FIG. 8.

Through the above steps, it is possible to obtain a package product of a solid-state battery in which a circuit for the solid-state battery is provided in the solid-state battery itself.

<<Surface Mounting on Substrate>>

The solid-state battery can be surface-mounted on a substrate via an external terminal and electrically connected thereto. In mounting the solid-state battery on the substrate, the positive electrode external terminal and the negative electrode external terminal are disposed at positions where the bonding material is applied onto the substrate terminal of the substrate so that the other main surface facing the main surface on which the circuit is provided in the solid-state battery is a surface on the mounting surface side. As the bonding material, a solder for electric wiring may be used. Thereafter, the positive electrode terminal and the negative electrode terminal are bonded to the substrate by a bonding material by solder reflow, and a battery mounting substrate is obtained. The external terminal may protrude from the covering insulating layer to have a convex shape, a gull wing shape, or a J-terminal shape.

Although the embodiments of the present invention have been described above, only typical examples have been illustrated. Those skilled in the art will easily understand that the present invention is not limited thereto, and various aspects are conceivable without changing the gist of the present invention.

In the above description, a more compact solid-state battery has been described, but the present invention is not particularly limited thereto. For example, the main surface forming layer has a characteristic that a circuit can be formed on the surface thereof, but due to the high sealing characteristic thereof, the main surface forming layer has an effect of preventing water vapor transmission into the solid-state battery. In addition, an effect of preventing foreign matters from being mixed into the solid-state battery from the external environment can be exhibited, and furthermore, it also contributes to prevention of leakage of the solid-state battery reactant to the outside.

The solid-state battery of the present invention can be used in various fields where battery use and electric storage are assumed. By way of example only, the solid-state battery of the present invention can be used in the field of electronics mounting. In addition, it can be used in the fields of electricity, information, and communication in which electricity, electronic equipment, and the like are used (for example, electric and electronic equipment fields or mobile equipment fields including mobile phones, smartphones, notebook computers and digital cameras, activity meters, arm computers, electronic papers, and small electronic machines such as RFID tags, card type electronic money, and smartwatches), home and small industrial applications (for example, the fields of electric tools, golf carts, and home, nursing, and industrial robots), large industrial applications (for example, fields of forklift, elevator, and harbor crane), transportation system fields (field of, for example, hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a research submarine), and the like.

### DESCRIPTION OF REFERENCE SYMBOLS

10: Section of solid-state battery
20: Positive electrode layer
30: Solid electrolyte layer
40: Negative electrode layer
50: Main surface forming layer
60: End-face electrode
70: External terminal
100: Main surface of solid-state battery
200: Circuit
210: Active element
220: Passive element
230: Wiring pattern
240: Input/output terminal electrode
300: Covering insulating layer
500: Solid-state battery

1. A solid-state battery comprising:
a solid-state battery laminate having a main surface configured as a circuit forming surface; and
a circuit that controls the solid-state battery on the main surface.

2. The solid-state battery according to claim 1, wherein the main surface of the solid-state battery laminate is a support surface that supports the circuit that controls the solid-state battery.

3. The solid-state battery according to claim 1, wherein the circuit includes at least one circuit selected from a protective circuit, a charge control circuit, a temperature control circuit, an output compensation circuit, and/or an output stabilization power supply circuit.

4. The solid-state battery according to claim 1, wherein an input/output terminal electrode is on the main surface of the solid-state battery laminate.

5. The solid-state battery according to claim 4, wherein the input/output terminal electrode is a surface mount terminal.

6. The solid-state battery according to claim 1, wherein an input/output terminal electrode is on a side surface of the solid-state battery laminate.

7. The solid-state battery according to claim 6, wherein the input/output terminal electrode is a surface mount terminal.

8. The solid-state battery according to claim 1, wherein the main surface of the solid-state battery laminate is an insulating layer having ion insulation properties.

9. The solid-state battery according to claim 8, wherein the insulating layer contains ceramics.

10. The solid-state battery according to claim 8, wherein the solid-state battery laminate comprises an integrally sintered body that includes a positive electrode layer, a negative electrode layer, a solid electrolyte layer interposed between the positive electrode layer and the negative electrode layer, and the insulating layer.

11. The solid-state battery according to claim 1, wherein the solid-state battery is a packaged solid-state battery.

12. The solid-state battery according to claim 1, further comprising a covering insulating layer covering the circuit.

13. The solid-state battery according to claim 12, wherein the covering insulating layer is stacked on the main surface.

14. The solid-state battery according to claim 12, wherein the covering insulating layer contains a resin material.

15. The solid-state battery according to claim 1, wherein the solid-state battery is a surface-mounted battery.

16. The solid-state battery according to claim 15, wherein the main surface having the circuit is a non-mounting surface side of the surface-mounted battery.

17. The solid-state battery according to claim 16, wherein the main surface is a first main surface, the circuit is a first circuit, the solid-state battery laminate has a second main surface opposite the first main surface that is a mounting surface side of the surface-mounted battery, and the solid-state battery further comprises:
a second circuit that controls the solid-state battery on the second main surface.

18. The solid-state battery according to claim 1, wherein the main surface is a first main surface, the circuit is a first circuit, the solid-state battery laminate has a second main surface opposite the first main surface, and the solid-state battery further comprises:
a second circuit that controls the solid-state battery on the second main surface.

19. The solid-state battery according to claim 10, wherein the positive electrode layer and the negative electrode layer in the solid-state battery laminate are layers capable of occluding and releasing lithium ions.
